(19) United States
(12) Patent Application Publication
(10) Pub. No.: US 2016/0216929 A1
(43) Pub. Date: Jul. 28, 2016

(54) PROCESSING APPLICATION INTERFACE

(71) Applicant: Alibaba Group Holding Limited, Grand Cayman (KY)

(72) Inventor: Chao Hua, Hangzhou (CN)

(21) Appl. No.: 15/003,616

(22) Filed: Jan. 21, 2016

(30) Foreign Application Priority Data
Jan. 22, 2015 (CN) 201510030948.6

(51) Int. Cl. G06F 3/14; G06F 3/0484; G06F 3/0481

(52) U.S. Cl. CPC G06F 3/1415; G06F 3/04817; G06F 3/04842; G06F 3/04847; G06F 2203/04806

(57) ABSTRACT

An application interface processing method includes: receiving, by an application interface processing apparatus, an interface presentation instruction to present an interface of a target application, the interface presentation instruction including an identifier of the target application and an identifier of a port for generating the interface corresponding to the target application; calling the port according to the identifier of the target application and the identifier of the port to generate the interface; and presenting the interface on a desktop. The techniques of the present disclosure present an interface more conveniently, and enhance the flexibility of interface presentation.

### CROSS REFERENCE TO RELATED PATENT APPLICATION

This application claims foreign priority to Chinese Patent Application No. 201510030948.6 filed on 22 Jan. 2015, entitled “Method and Apparatus for Processing Application Interface”, which is hereby incorporated by reference in its entirety.

### TECHNICAL FIELD

The present disclosure relates to the field of Internet technologies, and, more particularly, to an application interface processing method and apparatus.

### BACKGROUND

Users may install various applications on their terminals, and different applications have interfaces having different styles. In order to enhance the diversity and personalization of a desktop, a conventional technique called App Widget is used to directly present the application interface on the desktop.

When the App Widget is used, firstly, an App Widget program needs to be developed, and then, the developed App Widget program is installed on a terminal device. According to a user instruction, the App Widget program generates an application interface and presents the interface on a desktop of the terminal device.

Although the application interface is presented on the desktop by the App Widget program, the pattern of the presented interface and the information presented on the interface are determined by the APP Widget program. Moreover, a desktop that meets the application requirements cannot be flexibly presented, which results in poor flexibility.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides an application interface processing method and apparatus to present interfaces more conveniently and enhance flexibility of interface presentation.

An aspect of the present disclosure provides an application interface processing method, which includes the following operations:

an application interface processing apparatus receives an interface presentation instruction to present an interface of a target application, the interface presentation instruction including an identifier of the target application and an identifier of a port for generating the interface corresponding to the target application;

the application interface processing apparatus calls the port according to the identifier of the target application and the identifier of the port to generate the interface; and

the application interface processing apparatus presents the interface on a desktop.

Another aspect of the present disclosure provides an application interface processing apparatus, which includes:

a first receiving module for receiving an interface presentation instruction to present an interface of a target application, the interface presentation instruction including an identifier of the target application and an identifier of a port for generating the interface corresponding to the target application;

a generation module for calling the port according to the identifier of the target application and the identifier of the port to generate the interface; and

a presentation module for presenting the interface on a desktop.

In the present disclosure, the application interface processing apparatus calls the port of the target application according to the received interface presentation instruction to generate an interface of the target application, and presents the generated interface on a desktop so that the interface of the target application is presented on the desktop. Compared with conventional techniques, the target application of the present disclosure directly provides a port for generating an interface, which is to be called by the application interface processing apparatus, to generate and present the interface of the target application by calling the port provided by the target application, without developing a dedicated App Widget program. The interface pattern of the target application and the content presented by the interface are independently decided by the target application and are not restricted by the App Widget program. Thus, the techniques of the present disclosure are convenient to implement with high flexibility.

### BRIEF DESCRIPTION OF THE DRAWINGS

In order to explain technical solutions of the example embodiments of the present disclosure more clearly, a brief introduction of drawings that describes the example embodiments or the conventional techniques is provided below. Apparently, the drawings described below illustrate some example embodiments of the present disclosure. Other drawings may be acquired by those skilled in the art according to these drawings without creative efforts.

FIG. 1 is a schematic flow chart of an example application interface processing method according to an example embodiment of the present disclosure;

FIGS. 2-5 are schematic views of an interface of a lottery application on a desktop according to an example embodiment of the present disclosure;

FIG. 6 is a structural schematic view of an example desktop application apparatus according to an example embodiment of the present disclosure; and

FIG. 7 is a structural schematic view of an example desktop application apparatus according to another example embodiment of the present disclosure.

### DETAILED DESCRIPTION

To make the objectives, technical solutions, and advantages of the example embodiments of the present disclosure more comprehensible, the technical solutions in the example embodiments of the present disclosure are described in the following with reference to the accompanying drawings. Apparently, the example embodiments merely represent a part and not all of the embodiments of the present disclosure. All other embodiments acquired by persons of ordinary skill in the art based on the example embodiments of the present disclosure without creative efforts shall belong to the protection scope of the present disclosure.

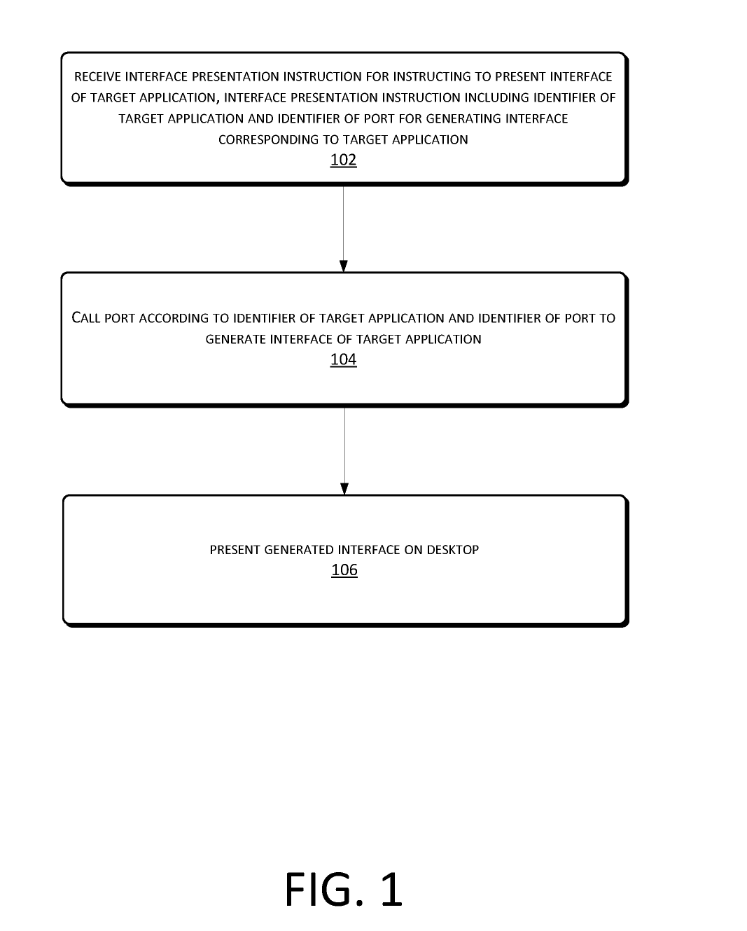

FIG. 1 is a schematic flow chart of an example application interface processing method according to an example embodiment of the present disclosure. As shown in FIG. 1, the method includes:

At 102, an application interface processing apparatus receives an interface presentation instruction to present an interface of a target application, the interface presentation instruction including an identifier of the target application and an identifier of a port for generating the interface corresponding to the target application.

At 104, the application interface processing apparatus calls the port according to the identifier of the target application and the identifier of the port to generate an interface of the target application.

At 106, the application interface processing apparatus presents the generated interface on a desktop.

The example embodiment provides an application interface processing method, which is executable by an application interface processing apparatus. The application interface processing apparatus may be an application provided by various operating systems and used for implementing a desktop on a terminal device, which may be abbreviated as a desktop application. The operating system may be Android™, IOS™, Symbian™ Windows™ mobile series, Linux™, and so on. For example, the terminal device may be a cell phone, a notebook, a desktop computer, or a tablet computer. Alternatively, the application interface apparatus may also be a third-party application or a plug-in for a certain application.

The target application refers to any application that needs to be installed or has been installed on a terminal device and needs the terminal device to implement a particular function, which may be, for example, a lottery application, a Tmall™ application, a music application, a weather report application, a navigation application, and so on. For example, the target application may be installed on a terminal device by a user manually, or the installation of the target application may be executed by a push from a server.

In a practical application, in order to enhance the diversity and personalization of the desktop, an interface of the target application may be directly presented on a desktop. In addition, since the interface of the target application is directly presented on the desktop, a user may directly operate on the interface, instead of operating an icon of the target application to enter the interface of the target application and then operating the interface as provided in the conventional techniques. Therefore, presenting the interface of the target application directly on the desktop facilitates user operations.

In order to directly present an interface of a target application on a desktop, an App Widget program has been developed by conventional techniques. However, in such a case, the presented pattern of the interface and content of the interface are restricted by the App Widget program, which results in poor flexibility. Thus, the example embodiment provides an interface presentation method implemented by an application interface processing apparatus. How the application interface processing apparatus presents an interface of a target application on a desktop is described below in detail.

For example, an application interface processing apparatus receives an interface presentation instruction. The interface presentation instruction is used for instructing to present an interface of a target application on a desktop. Meanwhile the interface presentation instruction includes an identifier of the target application and an identifier of a port for generating the interface corresponding to the target application. The identifier of the port may be a name or an ID of the port, and so on.

Upon receipt of the interface presentation instruction, the application interface processing apparatus calls the port for generating the interface corresponding to the target application according to the identifier of the target application and the identifier of the port included in the interface presentation instruction to generate the interface of the target application, and presents the generated interface of the target application on a desktop to present the interface of the target application.

Alternatively, in the example embodiment, the application interface processing apparatus may be a desktop application implementing a desktop. On this basis, the application interface processing apparatus not only implements a desktop of a terminal device, but also presents an interface of a target application on the implemented desktop. The implementation of a desktop of a terminal device by the application interface processing apparatus is conventional and is not the focus of the example embodiment. Thus, such implementation is not detailed herein.

As shown from the above, in the method of the example embodiment, the target application directly provides a port for generating an interface (which is to be called by the application interface processing apparatus) to generate and present the interface of the target application by calling the port provided by the target application, without developing a dedicated App Widget program. The interface pattern of the target application and the content presented by the interface are independently decided by the target application without restriction by the App Widget program. Thus, the techniques of the present disclosure are convenient to implement with high flexibility.

The operations at 102 may be implemented in, but are not limited to, the following alternative implementations:

In an alternative implementation, after a target application is installed on a terminal device where the application interface processing apparatus is located, an interface icon is provided on a desktop, which is used for a user to send an interface presentation instruction. Accordingly, when there is a need to present an interface of the target application on the desktop, by operating the interface icon, the user sends to the application interface processing apparatus an interface presentation instruction to present the interface of the target application. Correspondingly, the application interface processing apparatus receives the interface presentation instruction sent by the user who operates the interface icon provided by the target application. In the implementation, the interface icon of the target application may be associated with the identifier of the target application and the identifier of the port for generating the interface corresponding to the target application. Accordingly, the interface presentation instruction sent by the user who operates the interface icon of the target application will automatically carry the identifier of the target application and the identifier of the port for generating the interface corresponding to the target application.

The methods for the user to operate the interface icon include, but not are limited to: drag, click (single click, right click, or double click), long press, mouse over, and so on.

The interface icon may be an icon that is different from an application icon of the target application, or may be an application icon of the target application. It is worth noting that, when the interface icon is the application icon of the target application, in order to be compatible with the conventional techniques, the methods that the user may operate the interface icon (for sending the interface presentation instruction) may be operations other than those of operating the icon in the conventional techniques such as a click operation for entering the application interface).

In another alternative implementation, the target application may also actively send an interface presentation instruction to the application interface processing apparatus to instruct the application interface processing apparatus to present an interface of the target application on a desktop. Correspondingly, the application interface processing apparatus receives the interface presentation instruction sent by the target application. For example, the target application may preset a sending time, and when the preset sending time is reached, send the interface presentation instruction to the application interface processing apparatus. Alternatively, the target application may preset a sending condition (for example, receipt of new information), and when the preset sending condition is satisfied, send the interface presentation instruction to the application interface processing apparatus. In the implementation, the target application is pre-stored with an identifier of a port for generating an interface corresponding to the target application. When the interface presentation instruction is sent to the application interface processing apparatus, the identifier of the port and the identifier of the target application may be added directly to the interface presentation instruction.

In still another alternative implementation, the interface presentation of the target application may be combined with a server corresponding to the target application, which better use the cloud end service when the server is located at a cloud end. Accordingly, the server corresponding to the target application may send an interface presentation instruction to the application interface processing apparatus to control the interface presentation of the target application. Correspondingly, the application interface processing apparatus receives the interface presentation instruction sent by the server corresponding to the target application. For example, when the server needs to recommend a service or information to a user terminal, it may send the interface presentation instruction to an application interface processing apparatus of the corresponding terminal. In the implementation, the server is pre-stored with an identifier of the target application and an identifier of a port for generating an interface corresponding to the target application. When the interface presentation instruction is sent to the application interface processing apparatus, the identifier of the port and the identifier of the target application are added directly to the interface presentation instruction.

The operations at 104 may be implemented in, but are not limited to, the following alternative implementations.

The application interface processing apparatus, according to the identifier of the target application and the identifier of the port for generating the interface corresponding to the target application, calls the port to acquire interface generation information.

The application interface processing apparatus generates an interface of the target application according to the interface generation information.

In an alternative implementation, the port for generating the interface corresponding to the target application may be a plug-in that is independent from the target application and is available to use by the target application. The plug-in is mainly used for generating interfaces for various application programs.

In an alternative implementation, the application interface processing apparatus provides a class port to the target application. A third-party service developer (for example, a developer of the target application) may extend the class port, and implement a class for generating the interface corresponding to the target application. That is to say, the port for generating the interface corresponding to the target application is based on a class implemented by a class port provided by the application interface processing apparatus to the target application. For example, a class port for various target applications is abstracted according to user needs and interactive requirements between the interface and the application interface processing apparatus. For example, the abstracted class port may be as follows:
public abstract class BaseCardModel {. . . . . . . . . }.

The class generating the interface implemented based on the class port corresponding to the target application may include:
public for abstract View getSmallCardView(state, state);
public abstract View getDetailSmallCardView(state, state);
. . .

It is worth noting that the class for generating the interface corresponding to the target application is implemented based on the class port provided by the application interface processing apparatus. On one hand, through such class port, an interaction between the target application and the application interface processing apparatus is implemented. On the other hand, the application interface processing apparatus is implemented without knowing the specific implementation of interface generation. Thus, in terms of change in the interface, there is no need to upgrade the application interface processing apparatus.

Based on the class for generating the interface corresponding to the target application, the interface presentation instruction received by the application interface processing apparatus may include an identifier of the target application and a name of the class for generating the interface of the target application corresponding to the target application.

The application interface processing apparatus may determine a class for generating the interface corresponding to the target application according to the identifier of the target application and the name of the class, and adopt a reflection mechanism to execute the class to acquire an object instance of the class, the object instance including the interface generation information; then, run the object instance to generate the interface of the target application.

The interface generation information may include: an interface style, interface layout information, resource information of content presented on the interface (for example, a button picture), an interface background color, and so on.

In the implementation, by extending the target application, the target application will include the class for generating the interface, which is responsible for generating the interface. The application interface processing apparatus only needs to execute the class by using a reflection mechanism to acquire an object instance of the class to thereby generate the interface by executing the object instance, which is equivalent to encapsulating the generation of the interface in the target application. The target application may generate any interface according to scenario needs and is not restricted by the App Widget program. Therefore, the implementation can implement either a simple logic interface or a complicated logic interface.

On the basis of the above examples or example embodiments, the operations at 106 may be implemented in, but are not limited to, the following alternative implementations.

In an alternative implementation, after the generation of the interface of the target application, the application interface processing apparatus may directly display the interface of the target application on a desktop according to its own logic. For example, the application interface processing apparatus may determine a presentation position of the interface of the target application on the desktop according to a current layout of the desktop and a size of the generated interface of the target application, and further present at such position.

In another alternative implementation, the target application may actively control the presentation of the interface on the desktop. On this basis, the target application sends presentation control information to the application interface processing apparatus to enable the application interface processing apparatus to present the interface of the target application on the desktop according to the presentation control information. Correspondingly, the application interface processing apparatus receives the presentation control information sent by the target application. According to the requirement of the presentation control information, the interface of the target application is presented on the desktop implemented by the application interface processing apparatus.

In still another alternative implementation, the interface presentation of the target application on the desktop may be controlled by a server corresponding to the target application. On this basis, the server corresponding to the target application may send presentation control information to the application interface processing apparatus to enable the application interface processing apparatus to present the interface of the target application on the desktop according to the presentation control information. Correspondingly, the application interface processing apparatus receives the presentation control information sent by the server corresponding to the target application. According to the requirement of the presentation control information, the interface of the target application is presented on the desktop implemented by the application interface processing apparatus.

It is worth noting that the presentation control information may include: a presentation position on the desktop, a time duration for presentation on the desktop, a starting time for presentation on the desktop, a validity for presentation on the desktop, and so on.

Alternatively, the target application or the server corresponding to the target application may carry the presentation control information in the interface presentation instruction and send them together to the application interface processing apparatus. Correspondingly, the application interface processing apparatus acquires presentation control information from the interface presentation instruction to further control the interface presentation on the desktop according to the presentation control information.

On the basis of the above examples and example embodiments, after presenting the interface of the target application on the desktop, the application interface processing apparatus may also update the interface of the target application to enhance the flexibility for interface presentation.

The updating, by the application interface processing apparatus, the interface may include:

updating a pattern of the interface according to a pattern of the desktop; and/or

updating content of the interface.

In case of updating a pattern of the interface, some examples may include: when a desktop switches screen orientation, the application interface processing apparatus may update the presented pattern of the interface to make the presented interface adapt to the pattern of the desktop.

In case of updating content of the interface, some examples may include: provided that the interface presents various objects, such as products, a user may click on the object to access a detail page of the object, which is equivalent to sending an instruction to update the current content of the interface to be the detail page of the object that the user clicks. The application interface processing apparatus receives a detail page access instruction sent by the user, the detail page access instruction being used for requesting to access the detail page of the object presented on the interface; according to the detail page access instruction, the application interface processing apparatus updates the content of the current interface to be information of the detail page.

In case of updating content of the interface, some examples may include: after presenting the interface of the target application on the desktop, the application interface processing apparatus may monitor an interface update instruction for the interface. The interface update instruction may either be sent by the target application or by a server corresponding to the target application. For example, in case of a change in the content of the interface, the application interface processing apparatus may receive an interface content update instruction sent by the target application or by the server corresponding to the target application; and update the content of the interface of the target application according to the interface content update instruction.

The application interface processing apparatus may update the interface of the target application in the following alternative example implementations:

In an implementation, the interface update instruction may include an interface update demand. For example, the application interface processing apparatus may directly update the interface of the target application, such as updating a style of the interface, a pattern of the interface, or a button picture.

In another implementation, according to an interface update demand, the application interface processing apparatus re-calls the port for generating the interface corresponding to the target application by a reflection mechanism, introduces a parameter for generating a new interface to generate the new interface, and replaces the current interface with the new interface. Here, the new interface includes an interface whose pattern has changed and/or an interface whose content has changed. The implementation is equivalent to “killing” the original interface and to re-generating the new interface.

In still another implementation, in addition to the port for generating an interface, the target application may include a port for updating the interface. On this basis, according to the interface update demand, the application interface processing apparatus may re-execute the port for updating an interface corresponding to the target application by a reflection mechanism to refresh the previous interface, and acquire a refreshed interface, that is, a new interface, to update the interface.

On the basis of the above examples and example embodiments, after presenting the interface of the target application on the desktop, the application interface processing apparatus may further operate the interface, which enhances the flexibility of interface operation.

For example, the application interface processing apparatus may receive the interface operation instruction and operate the interface according to the interface operation instruction.

The interface operation instruction may be sent by a user. For example, the interface operation instruction may be sent by the user who operates the interface or content in the interface (for example, a button).

In the implementation, the interface operation instruction may either include an instruction for operating the interface or an instruction for operating content in the interface. For example, the interface operation instruction may be an operation instruction for changing a position for interface presentation, or an operation instruction for zooming in the interface, or an operation instruction for zooming out the interface, or an operation instruction for selecting a certain button in the interface.

Based on the above, the operating, by the application interface processing apparatus, the interface according to the interface operation instruction may be an operation on the interface, for example, a change of a presentation position for interface by moving the interface, zoom in the interface or zoom out the interface; or an operation on the content in the interface, for example, a click on a certain button or menu in the interface, etc.

It is worth noting that, with respect to the interface operation instruction to operate the interface, the application interface processing apparatus may receive the instruction directly, and carry out corresponding operations on the interface according to the received interface operation instruction directly. With respect to the interface operation instruction to operate content in the interface, generally, the target application may receive the instruction directly. The target application, by calling back a class port provided by the application interface processing apparatus, forwards the received interface operation instruction to the application interface processing apparatus. Then, the application interface processing apparatus performs corresponding operations on the interface according to the interface operation instruction forwarded by the target application.

Furthermore, the application interface processing apparatus of the example embodiment may provide a port for callback to the target application. On this basis, when the application interface processing apparatus operates the interface, the target application is allowed to interact with the application interface processing apparatus by calling back the port provided by the application interface processing apparatus to operate the interface.

For example, when operating the interface, the application interface processing apparatus receives operation information returned from the target application that calls back the port provided by the application interface processing apparatus; and executes a relevant operation according to the operation information to operate the interface.

For example, the operation information may be result information for indicating whether an operation is successful or not (for example, the operation is successful or the operation fails), or instruction information for instructing a next operation, or information of the interface after operation, for example, a size of the interface after zooming.

Provided that the interface operation instruction is used for instructing an interface zooming, the operation information may be a size of an interface after zooming. On this basis, the application interface processing apparatus may specifically adjust a layout of the desktop according to the size of the interface after zooming to present the interface after zooming on the desktop. The adjustment to the desktop layout may specifically include: moving, deleting, and/or zooming in/out other icons or views on the desktop.

Compared with the conventional techniques, the target application of the present disclosure directly provides a port for generating an interface, which is to be called by the application interface processing apparatus, to generate and present the interface of the target application by calling the port provided by the target application, without developing a dedicated App Widget program. The interface pattern of the target application and the content presented by the interface are independently decided by the target application and are not restricted by the App Widget program. Thus, the techniques of the present disclosure are convenient to implement with high flexibility.

An alternative implementation of the technical solution of the present disclosure is described below in case of presenting an interface of a lottery application on a desktop and using the application interface processing apparatus as a desktop application apparatus.

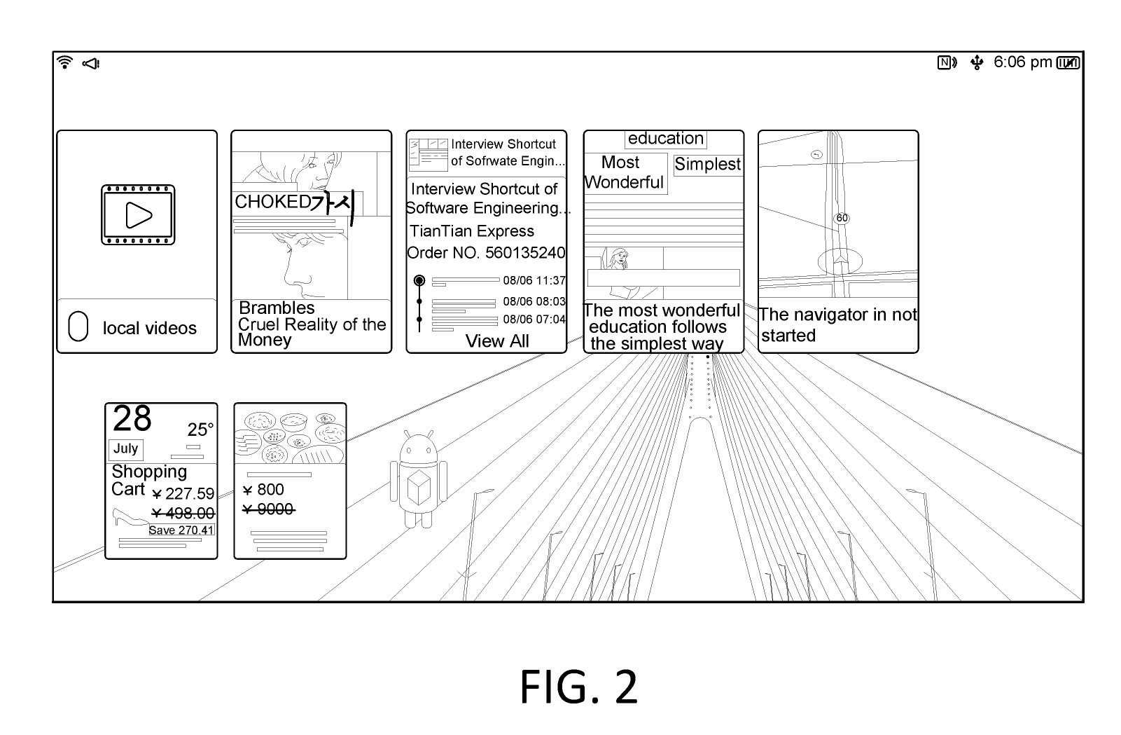

When it is necessary to present an interface of a lottery application on a desktop of a terminal device, the lottery application is installed on the terminal device, and at this point, the lottery application may provide an interface icon on the desktop, as shown in FIG. 2. FIG. 2 shows the desktop of the terminal device. On the upper part of the desktop, interfaces of several other target applications are presented. On the lower part of the desktop, a “robot” icon is the interface icon provided by the lottery application. By dragging the interface icon, a user sends an interface presentation instruction to the desktop application apparatus.

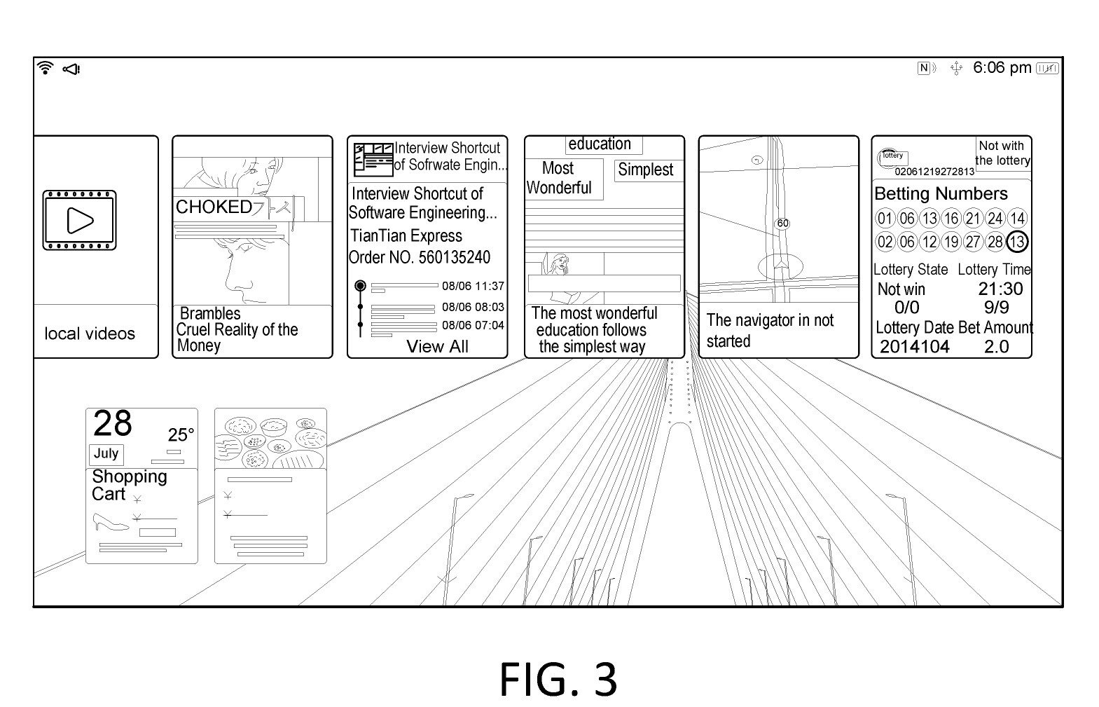

The user drags the “robot” icon upwards, and an interface presentation instruction is sent to the desktop application apparatus. The desktop application apparatus executes a corresponding part in the method flow of the above example embodiments according to the interface presentation instruction to generate the interface of the lottery application, and presents the interface on the desktop, as shown in FIG. 3. At the most right side of the upper part of the desktop, as shown in FIG. 3, there is the interface of the lottery application.

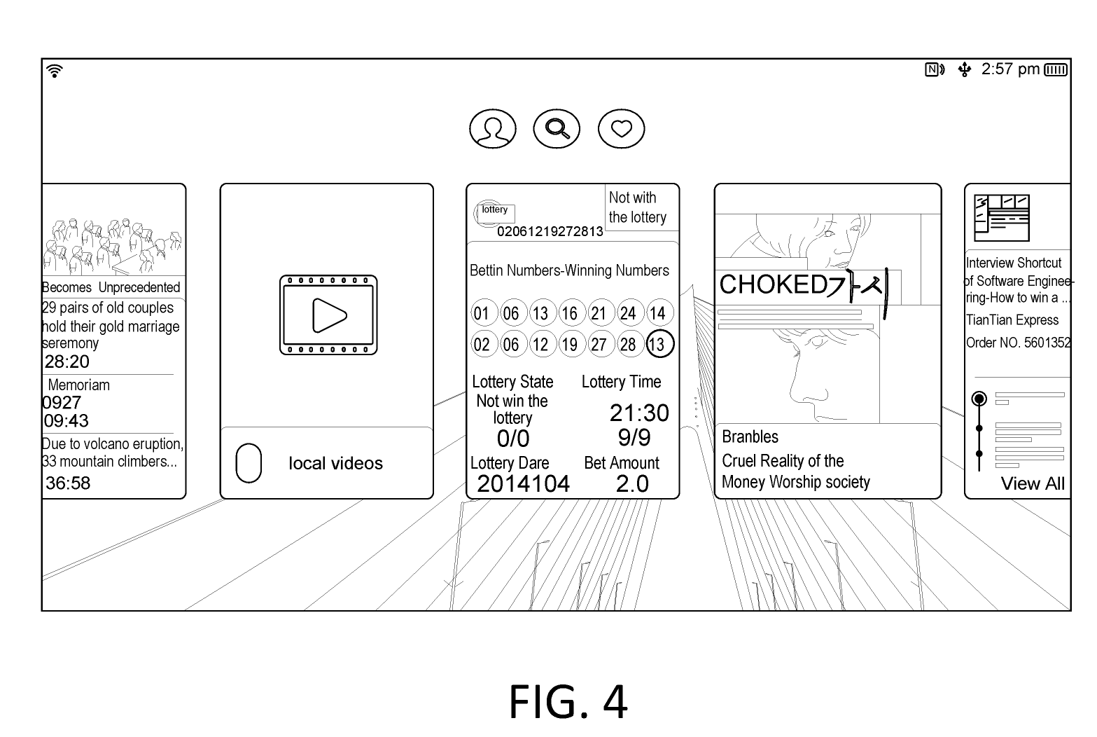

If the user wants to change a presentation position of the interface on the desktop, an interface operation instruction to change an interface position is sent to the desktop application apparatus. For example, the interface operation instruction may be sent by dragging the interface. The desktop application apparatus changes the presentation position of the interface of the lottery application according to the interface operation instruction, as shown in FIG. 4.

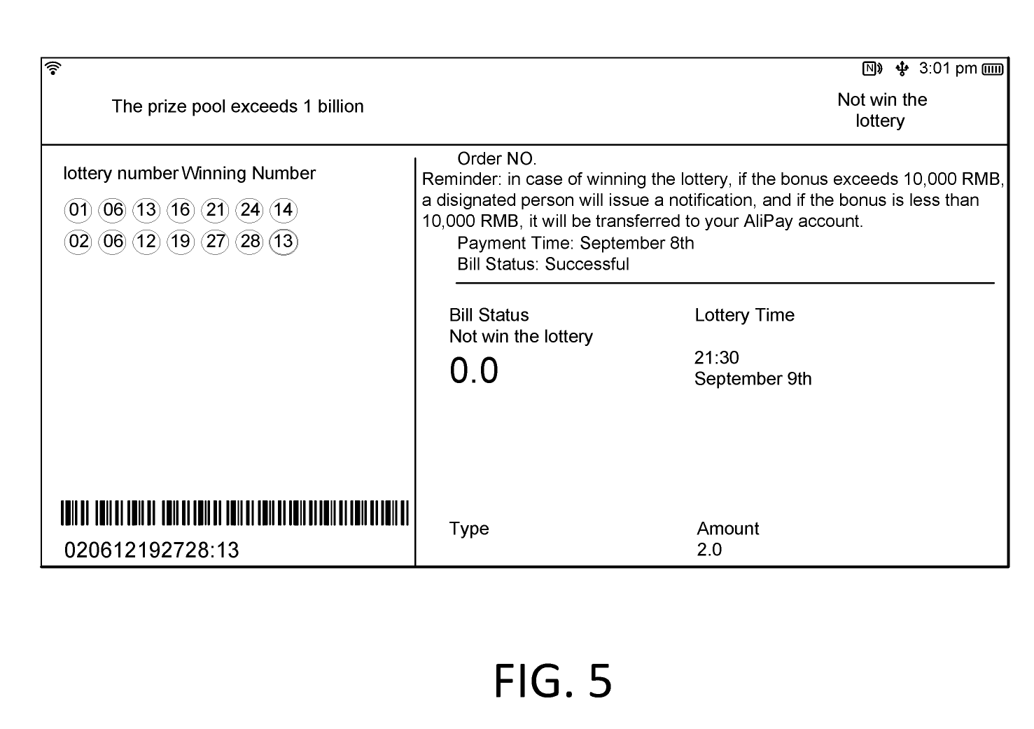

If the user wants to zoom in the interface, an interface operation instruction to zoom in the interface may be sent to the desktop application apparatus. For example, the interface operation instruction may be sent by double clicking a particular position on the interface. The desktop application apparatus zooms in the interface of the lottery application to the whole desktop according to the interface operation instruction, as shown in FIG. 5.

It should be noted that, with respect to the method example embodiments, for ease of description, they are all expressed as a combination of a series of actions, but persons skilled in the art should know that, the present disclosure is not limited to the described action sequence because, according to the present disclosure, some operations or steps may be performed in other sequences or simultaneously. Next, persons skilled in the art should also know that, the embodiments described in the specification are example embodiments, and not all of the involved actions and modules are necessary according to the present disclosure.

In the above example embodiments, various example embodiments focus on different aspects. For the part not described in detail in a certain example embodiment, reference may be made to relevant description in other example embodiments.

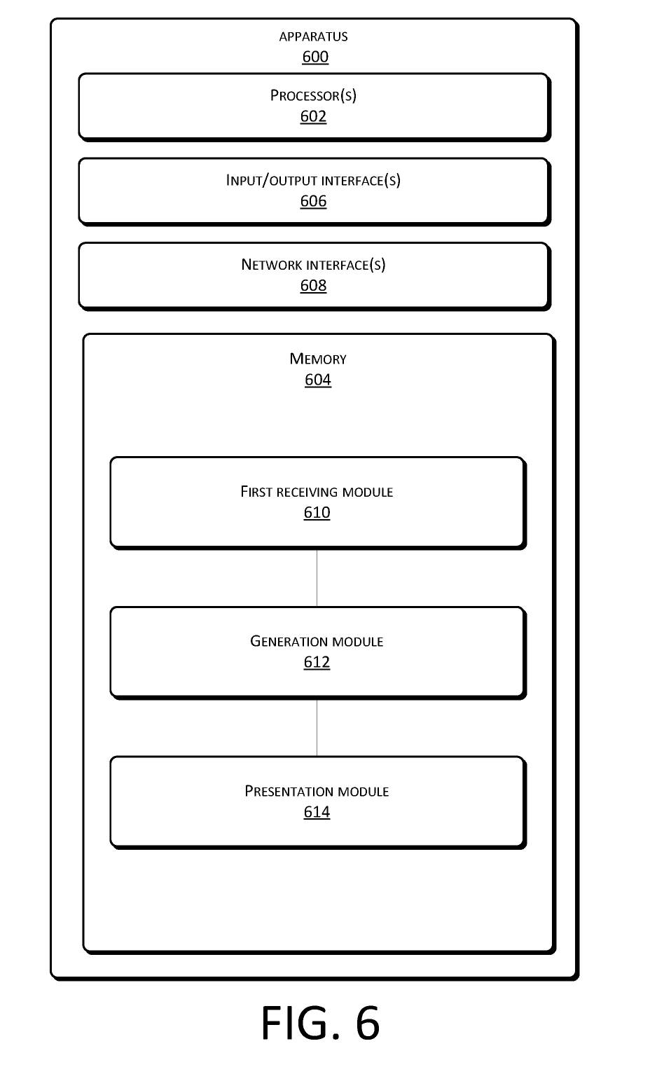

FIG. 6 is a structural schematic view of an application interface processing apparatus 600 according to an example embodiment of the present disclosure. As shown in FIG. 6, the apparatus 600 includes one or more processor(s) 602 or data processing unit(s) and memory 604. The apparatus 600 may further include one or more input/output interface(s) 606, and network interface(s) 608. The memory 604 is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 604 may store therein a plurality of modules or units including a first receiving module 610, a generation module 612, and a presentation module 614.

The first receiving module 610 receives an interface presentation instruction to present an interface of a target application, the interface presentation instruction including an identifier of the target application and an identifier of a port for generating the interface corresponding to the target application. The identifier of the port may be a name or an ID of the port and so on.

The generation module 612, connected with the first receiving module 610, calls the port according to the identifier of the target application and the identifier of the port received by the first receiving module 610 to generate the interface.

The presentation module 614, connected with the generation module 612, presents the interface generated by the generation module 612 on the desktop.

In an alternative example embodiment, the first receiving module 610 may further perform the following operations:

receiving the interface presentation instruction sent by a user who operates an interface icon provided by the target application, wherein the interface icon of the target application may be associated with the identifier of the target application and the identifier of the port for generating the interface corresponding to the target application. Accordingly, the interface presentation instruction sent by the user who operates the interface icon of the target application will automatically carry the identifier of the target application and the identifier of the port for generating the interface corresponding to the target application;

receiving the interface presentation instruction sent by the target application, wherein the target application is pre-stored with an identifier of a port for generating an interface corresponding to the target application, and when the interface presentation instruction is sent to the application interface processing apparatus, the identifier of the port and the identifier of the target application are added directly to the interface presentation instruction; or

receiving the interface presentation instruction sent by a server corresponding to the target application; wherein the server is pre-stored with an identifier of the target application and an identifier of a port for generating an interface corresponding to the target application, and when the interface presentation instruction is sent to the application interface processing apparatus, the identifier of the port and the identifier of the target application are added directly to the interface presentation instruction.

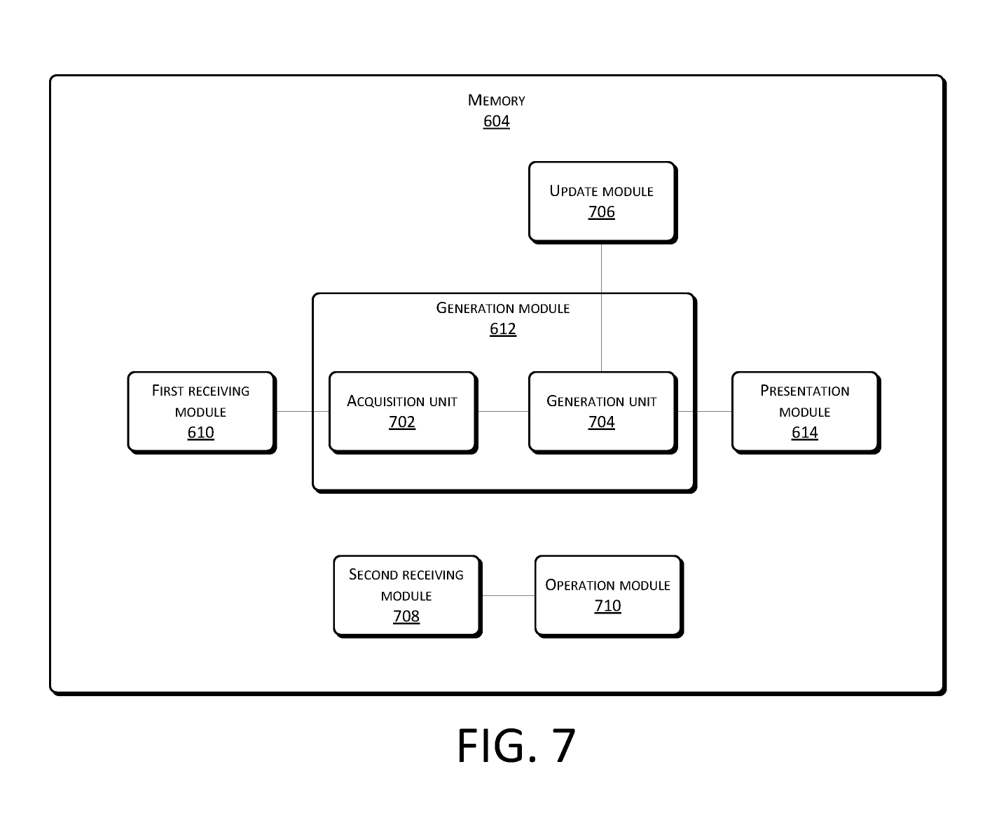

In an alternative example embodiment, as shown in FIG. 7, an implementation of the generation module 612 includes: an acquisition unit 702 and a generation unit 704.

The acquisition unit 702 calls a port according to an identifier of the target application and an identifier of the port to acquire interface generation information.

The generation unit 704, connected with the acquisition unit 702, generates an interface according to the interface generation information acquired by the acquisition unit 702.

In an alternative example embodiment, the port used for implementing the interface may be a plug-in that is independent of the target application but can be used by the target application, and the plug-in is mainly used for generating an interface for various applications.

In an alternative example embodiment, the port used for implementing the interface is based on a class implemented by a class port provided by the application interface processing apparatus to the target application.

Furthermore, the acquisition unit 702 may perform the following operations: determining a class according to the identifier of the target application and a name of the class; executing the class by adopting a reflection mechanism to acquire an object instance of the class, the object instance including the interface generation information. Correspondingly, the generation unit 704 runs the object instance to generate the interface.

In an alternative example embodiment, the presentation module 614 receives presentation control information sent by the target application or sent by a server corresponding to the target application; and presents the interface on the desktop according to the requirement of the presentation control information.

In an alternative example embodiment, as shown in FIG. 7, the apparatus 600 may further include an update module 706 stored on memory 604.

The update module 706 updates the interface generated by the generation module 612.

In an alternative example embodiment, the update module 706 performs the following operations:

updating a pattern of the interface according to a pattern of the desktop; and/or

updating content of the interface.

In an alternative example embodiment, the update module 706 performs the following operations:

receiving a detail page access instruction sent by a user, the detail page access instruction being used for requesting to access a detail page of an object presented on the interface; and

updating the content of the interface to be information of the detail page according to the detail page access instruction.

In an alternative example embodiment, the update module 706 performs the following operations:

re-calling the port and introducing a parameter for generating a new interface to generate the new interface; and

replacing the interface with the new interface.

In an alternative example embodiment, as shown in FIG. 7, the apparatus 600 may further includes a second receiving module 708 and an operation module 710 stored on memory 604.

The second receiving module 708 receives an interface operation instruction.

The operation module 710, connected with the second receiving module 708, operates the interface updated by the generation module 612 or the update module 706 according to interface operation instruction received by the second receiving module 708.

In an alternative example embodiment, the operation module 710 performs the following operations:

when operating the interface, receiving operation information returned by calling back, by the target application, the port provided by the application interface processing apparatus; and

executing relevant operations according to the operation information to operate the interface.

Alternatively, the operation information includes: a size of the interface after zooming. The operation module 710 performs the following operations: adjusting a layout of the desktop according to the size of the interface after zooming to present the interface after zooming on the desktop.

In an alternative example embodiment, the application interface processing apparatus in the example embodiment may be, but not limited to, a desktop application implementing the desktop.

The application interface processing apparatus in the example embodiment, in cooperation with the target application, enables the target application to directly provide a port for generating the interface and generates and presents an interface for the target application by calling the port provided by the target application without developing a dedicated App Widget program, and the interface pattern of the target application and the content presented by the interface are independently decided by the target application and are not restricted by the App Widget program, which is convenient to implement with high flexibility.

It is understood by a person skilled in the art that, for the purpose of convenient and brief description, with respect to specific working processes of the foregoing system, apparatus, and units, reference may be made to corresponding processes in the foregoing method example embodiments, and details are not described herein again.

In the several example embodiments provided in the present disclosure, it should be understood that the disclosed system, apparatus, and method may be implemented in other manners. For example, the described apparatus example embodiment is merely exemplary. For example, the division of units is merely a division of logical functions and there may be other divisions in actual implementation. For example, a plurality of units or components may be combined or integrated into another system, or some features may be ignored or not executed. In addition, the displayed or discussed mutual couplings or direct couplings or communication connections may be implemented through indirect couplings or communication connections between some ports, apparatuses or units, and may be implemented in electronic, mechanical, or other forms.

The units described as separate parts may be or not be physically separate, and parts displayed as units may be or not be physical units, and may be located in one position, or may be distributed on a plurality of network units. A part or all of the units may be selected according to actual needs to achieve the objectives of the solutions of the example embodiments.

In addition, functional units in the example embodiments of the present disclosure may be integrated into one processing unit, or each of the units may exist alone physically, or two or more units are integrated into one unit. The integrated unit may either be implemented in a form of hardware, or may be implemented in a form of hardware plus a software functional unit.

The integrated unit implemented in the form of a software functional unit may be stored in one or more computer-readable media. The software functional unit is stored in the computer-readable media and includes computer-executable instructions for instructing a computing device (which may be a personal computer, a server, or a network device) or processor to perform a part or all of the operations or steps of the methods described in the example embodiments of the present disclosure. The foregoing storage media include: any medium that stores program code, such as a USB flash drive, a removable hard disk, a read-only memory (ROM, Read-Only Memory), a random access memory (RAM, Random Access Memory), a magnetic disk, or an optical disc.

Finally, it shall be noted that: the above example embodiments are only used to describe the technical solutions of the present disclosure and shall not be used to limit the present disclosure. Although a detailed illustration to the present disclosure is given by reference to the above mentioned example embodiments, it should be appreciated for those skilled in the art that the technical solutions recorded in the example embodiments described above may be modified, or some of the technical features thereof may be replaced; and such modifications and replacements will not make the nature of the corresponding technical solutions depart from the spirit and scope of the technical solutions in the example embodiments of the present disclosure.

What is claimed is:

1. A method comprising:
receiving an interface presentation instruction to present an interface of a target application, the interface presentation instruction including an identifier of the target application and an identifier of a port for generating the interface;
calling the port according to the identifier of the target application and the identifier of the port to generate the interface; and
presenting the interface on a desktop.

2. The method of claim 1, wherein the receiving the interface presentation instruction to present the interface of the target application includes receiving the interface presentation instruction sent by a user who operates an interface icon provided by the target application.

3. The method of claim 1, wherein the receiving the interface presentation instruction to present the interface of the target application includes receiving the interface presentation instruction sent by the target application.

4. The method of claim 1, wherein the receiving the interface presentation instruction to present the interface of the target application includes receiving the interface presentation instruction sent by a server corresponding to the target application.

5. The method of claim 1, wherein the calling the port according to the identifier of the target application and the identifier of the port to generate the interface includes:
calling the port according to the identifier of the target application and the identifier of the port to acquire interface generation information; and
generating the interface according to the interface generation information.

6. The method of claim 5, wherein the port corresponds to the target application and is based on a class implemented by a class port provided to the target application.

7. The method of claim 6, wherein:
the calling the port according to the identifier of the target application and the identifier of the port to acquire interface generation information includes:
determining the class according to the identifier of the target application and a name of the class;
executing the class by adopting a reflection mechanism to acquire an object instance of the class, the object instance including the interface generation information; and
the generating the interface according to the interface generation information includes running the object instance to generate the interface.

8. The method of claim 1, wherein the presenting the interface includes:
presenting the interface on the desktop according to a requirement of presentation control information, wherein the presentation control information is received from the target application or from a server corresponding to the target application.

9. The method of claim 1, further comprising updating the interface: after the presenting the interface.

10. The method of claim 9, wherein the updating the interface includes updating a pattern of the interface according to a pattern of the desktop.

11. The method of claim 9, wherein the updating the interface includes updating a content of the interface.

12. The method of claim 11, wherein the updating the content of the interface includes:
receiving a detail page access instruction sent by a user, the detail page access instruction being used for requesting to access a detail page of an object presented on the interface; and
updating the content of the interface to be information of the detail page according to the detail page access instruction.

13. The method of claim 9, wherein the updating the interface includes:
re-calling the port;
introducing a parameter required for generating a new interface to generate the new interface; and
replacing the interface with the new interface.

14. The method of claim 1, further comprising:
after the presenting the interface,
receiving an interface operation instruction; and
operating the interface according to the interface operation instruction.

15. The method of claim 14, wherein the operating the interface according to the interface operation instruction includes:
receiving operation information returned by calling back the port; and
executing relevant operations according to the operation information to complete operating the interface.

16. The method of claim 15, wherein the operation information includes a size of the interface after zooming.

17. The method of claim 16, wherein the executing relevant operations according to the operation information to complete the operating the interface includes:
adjusting a layout of a desktop according to the size of the interface after zooming to present the interface after zooming on the desktop.

18. An apparatus comprising:
a first receiving module that receives an interface presentation instruction to present an interface of a target application, the interface presentation instruction including an identifier of the target application and an identifier of a port for generating the interface corresponding to the target application;
a generation module that calls the port according to the identifier of the target application and the identifier of the port to generate an interface; and
a presentation module that presenting the interface on a desktop.

19. The apparatus of claim 18, wherein the interface is presented on a desktop of a mobile terminal.

20. One or more memories stored thereon computer-executable instructions, executable by one or more processors, to cause the one or more processors to perform acts comprising:
receiving an interface presentation instruction to present an interface of a target application, the interface presentation instruction including an identifier of the target application and an identifier of a port for generating the interface;
calling the port according to the identifier of the target application and the identifier of the port to generate the interface; and
presenting the interface on a desktop.
